(19) United States
(12) Patent Application Publication
(10) Pub. No.: US 2021/0012022 A1
(43) Pub. Date: Jan. 14, 2021

(54) DATA DISTRIBUTION-TYPE INTEGRATED MANAGEMENT SYSTEM

(71) Applicant: SOFTCAMP CO., LTD., Gyeonggi-do (KR)

(72) Inventor: Hwan-Kuk BAE, Gyeonggi-do (KR)

(21) Appl. No.: 16/614,050

(22) PCT Filed: Apr. 6, 2018
(86) PCT No.: PCT/KR2018/004073

§ 371 Date: Nov. 15, 2019

(30) Foreign Application Priority Data
May 19, 2017 (KR) 10-2017-0062101

(51) Int. Cl. G06F 21/62; G06F 21/60; G06F 21/31; G06F 16/182; G06F 16/18; G06F 16/13

(52) U.S. Cl. CPC G06F 21/6218; G06F 21/602; G06F 16/13; G06F 16/1824; G06F 16/1873; G06F 21/31

(57) ABSTRACT

Provided is a system which can integrate and manage data, and more specifically to a data distribution-type integrated management system which can integrate and manage data without being equipped with a DBMS and a web server for the management of a large amount of data and can enhance the security performance of data. The data distribution-type integrated management system includes: a plurality of storage servers which separates and individually stores two or more types of information selected from among content information, attribute information, and version information which shared data includes; an execution management server which connects a execution module of a logged-in user terminal to the storage servers; and a search server which searches the storage servers for the corresponding shared data in response to a request from the user terminal.

### BACKGROUND

The present invention relates to a system which can integrate and manage data, and more specifically to a data distribution-type integrated management system which can integrate and manage data without being equipped with a DBMS and a web server for the management of a large amount of data and can also enhance data security performance.

As enterprise information assets have been replaced with electronic documents, the management of enterprise information assets based physical and human methods has exhibited limitations. Therefore, there has been a demand for technology for the effective management of overflowing data and a method of effectively sharing and utilizing data in an organization.

Since then, data centralization technology using a communication network, such as Ethernet or the Internet, has been proposed.

Conventional data centralization is based on Enterprise Contents Management (ECM), and is integrated platform technology for maximizing the management and utilization of various contents within an enterprise. In other words, ECM technology is a system management tool which can reduce the maintenance and operation costs of the system by integrating and managing various contents and systematically managing processes.

However, the conventional ECM technology has the burden of introducing an expensive foreign ECM system, such as EMC Documentum or Oracle UCM, and a problem arises in that response speed decreases considerably as the amount of data increases because all management target data must be stored and processed centrally.

It will apparent that it may be possible to utilize a common file server as a storage and management server for data centralization in place of the ECM technology in order to avoid the problems of the conventional ECM technology. However, a dedicated searcher must be provided for linkage with each file server, document management features, such as a per-data version management function and check-in/out functions, are limited, and only simple synchronization with the file server does not ensure sufficient security. Accordingly, the 100% centralization of corresponding data is impossible. In addition, a geometric increase in the amount of sub-data increasing in a data management process causes the problem of significantly reducing the operational efficiency of the file server.

As a result, an enterprise which must manage a large amount of data in electronic document format has to perform data centralization by using expensive conventional ECM technology, and inevitably has to bear the burden of increasing the number of expensive conventional ECM systems in order to maintain processing speed against an increase in the amount of data.

### SUMMARY OF THE INVENTION

The present invention has been conceived to overcome the above-described problems, and an object of the present invention is to provide a data distribution-type integrated management system which can eliminate a need for the introduction of an expensive system, such as a DBMS or the like, for the central management of data, can enhance data security, and can easily search for and execute centrally managed data only by means of the Explorer of a common OS.

In order to accomplish the above object, the present invention provides a data distribution-type integrated management system including:

a plurality of storage servers which separates and individually stores two or more types of information selected from among content information, attribute information, and version information which shared data includes;

an execution management server which connects a execution module of a logged-in user terminal to the storage servers; and

a search server which searches the storage servers for the corresponding shared data in response to a request from the user terminal.

The above-described present invention has the effects of eliminating a need for the introduction of an expensive system, such as a DBMS or the like, for the central management of data, enhancing data security, and easily searching for and executing centrally managed data only by means of the Explorer of a common OS.

### BRIEF DESCRIPTION OF DRAWINGS

FIG. 1 is a view schematically showing a communication relationship between the components of an integrated management system according to the present invention;

FIG. 2 is a block diagram showing the configuration of the integrated management system according to the present invention;

FIG. 3 is a flowchart sequentially showing the operation of the integrated management system according to the present invention;

FIGS. 4, 5, and 6 are images showing one embodiment of the login of the integrated management system according to the present invention;

FIG. 7 is an image showing one embodiment of the main window of the integrated management system according to the present invention;

FIG. 8 is an image showing an embodiment in which shared data is set to checkout in the integrated management system according to the present invention;

FIG. 9 is an image showing a popup window which displays the attribute information of shared data in the integrated management system according to the present invention;

FIGS. 10, 11, and 12 are UI images for the execution of the version-up of the integrated management system according to the present invention.

FIG. 13 is a page window image showing one of the attribute information of the integrated management system according to the present invention;

FIGS. 14, 15, and 16 are images showing one embodiment in which shared data before version-up and shared data after version-up are compared with each other in the integrated management system according to the present invention; and

FIGS. 17, 18, 19, and 20 are images showing one embodiment of the offline or emergency mode of the integrated management system according to the present invention.

### DETAILED DESCRIPTION OF THE INVENTION

The above-described features and effects of the present invention will be apparent from the following detailed description given in conjunction with the accompanying drawings, and thus those having ordinary skill in the art to which the present invention pertains can easily practice the technical spirit of the present invention. The present invention may be subject to various modifications and may have various forms, and specific embodiments will be illustrated in the drawings and described in detail in the specification. However, this is not intended to limit the present invention to a specific disclosure, but it should be understood that all modifications, equivalents, and substitutes included in the spirit and scope of the present invention are included. The terms used herein are used merely for the purpose of describing specific embodiments, and are not intended to limit the present invention.

Details of the present invention will be described in detail below based on the accompanying drawings.

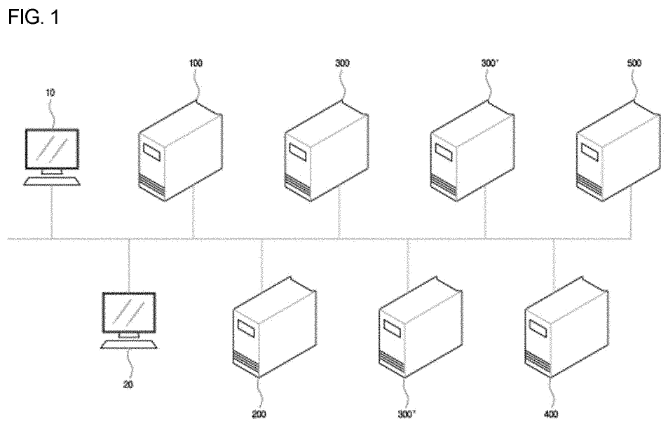

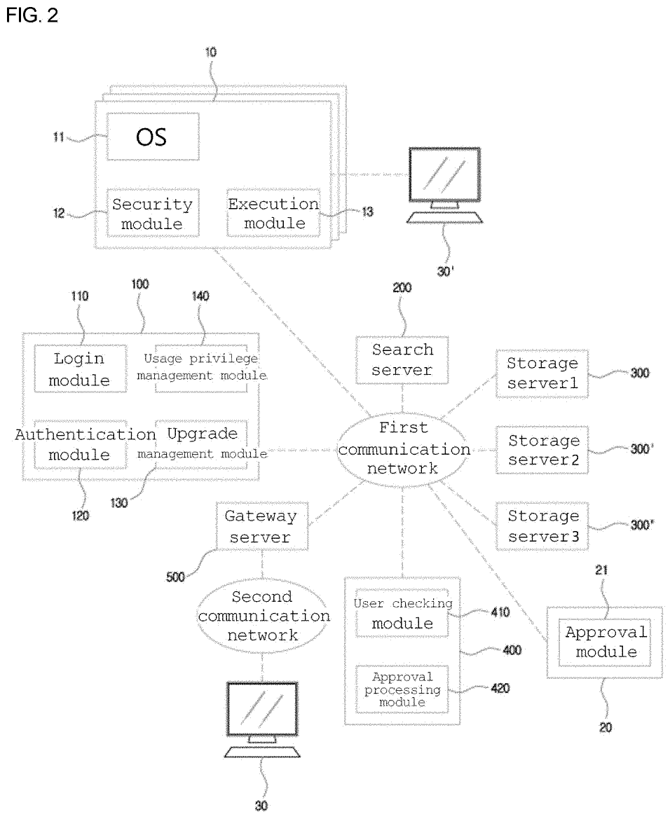

FIG. 1 is a view schematically showing a communication relationship between the components of an integrated management system according to the present invention, and FIG. 2 is a block diagram showing the configuration of the integrated management system according to the present invention.

The integrated management system according to the present invention is data security technology which stores shared data in separate central storage, not in local storage, and enables a user having viewing and editing privileges to share the shared data. Furthermore, the integrated management system according to the present invention allows the central storage to be implemented with common storage servers other than a DB server equipped with a DBMS. Furthermore, the integrated management system according to the present invention distributes and stores shared data associated with sub-data, thereby increasing corresponding shared data-related security. Furthermore, the integrated management system according to the present invention actively and automatically searches for a reference file associated with specific shared data in the storage server and then executes the reference file. For this purpose, the integrated management system of the present embodiment includes: an execution management server 100 determines whether a user has access privileges; storage servers 1 to 3 300, 300′ and 300″ (hereinafter referred to as ‘storage servers 300’) which store shared data; a search server 200 which searches for shared data selected by the user or shared data corresponding to a search keyword in the storage servers 300; and a privilege management server 400 which determines whether the user has data viewing, editing or outputting privileges and controls the approval processing of an administrator; and may further include a gateway server 500 which relays communication between a first communication network and a second communication network. In this case, each of the storage servers 300 is a type of storage device connected to a network, and stores file-level data. In other words, the storage server 300 is a device which can store file-level data in another device connected to a network. The storage server is advantageous in that the installation of the device is easy and inexpensive because it can be built with a simple operating system (OS) using network control and a configuration method.

The integrated management system of the present embodiment will be described more specifically. As shown in FIG. 2, at least one user terminal 10 is connected to the integrated management system via the first communication network, and a dedicated application is installed on the user terminal 10 in order to perform the connection. The dedicated application is installed based on an OS 11 which controls the operation of the user terminal 10. The dedicated application includes: a security module 12 which operates for the purpose of the security of the input and output of shared data while operating in conjunction with the integrated management system; and an execution module 13 which sends and receives corresponding shared data while operating in conjunction with an application for executing shared data, such as Word, Excel, or the like, and executes and searches for the shared data. Additionally, the application may be a sending and reception-dedicated program via an external communication network, such as groupware or an e-mail program, or the like. For reference, the execution module 13 of the present embodiment operates in conjunction with the Windows Explorer Dashboard UX of the Windows OS 11, through which a user can search, execute and store shared data as if the user used Explorer of Windows®, which is an example of the OS 11.

The security module 12 is a typical security solution, and blocks not only the illegitimate execution, illegitimate storage, illegitimate online sending/reception, etc. of the shared data but also the reception of malware, etc. For this purpose, the security module 12 blocks the illegitimate access between the local area of the user terminal 10 and the storage servers 300.

The execution module 13 executes the shared data via another application while operating in conjunction with the OS 11 of the user terminal 10, and outputs information about the shared data stored and managed by the integrated management system so that the user can check the information. Additionally, there are provided the services of searching the shared data and performing shared data-related general data management.

The execution management server 100 includes: a login module 110 which processes whether to log in to the integrated management system by checking an ID/PW input to the user terminal 10 by a user; an authentication module 120 which determines whether the user terminal 10 which has attempted a login has been authenticated; an upgrade management module 130 which performs the upgrade, patch, etc. of a dedicated application which is installed on the user terminal 10; and a usage privilege management module 140 which checks the shared data using privilege of the user having performed login and limits a viewing privilege.

Each of the storage server 300 stores shared data. An example of the storage server 300 may be an NAS server, an SAN server, a WINDOWS/LINUX server, or the like which is typical storage. In other words, the storage server 300 of the present embodiment does not need to be equipped with a separate DBMS for the management of shared data, etc. The storage servers 300 of the present embodiment may distribute, store, and manage content information, attribute information and version information (meta information) related to shared data into a plurality of storage servers 300, and the plurality of storage servers 300 may communicate over different communication networks rather than communicating with the same first communication network. In other words, the plurality of storage servers 300 may be disposed in different areas, and may perform communication connection over a public communication network, such as the Internet or the like.

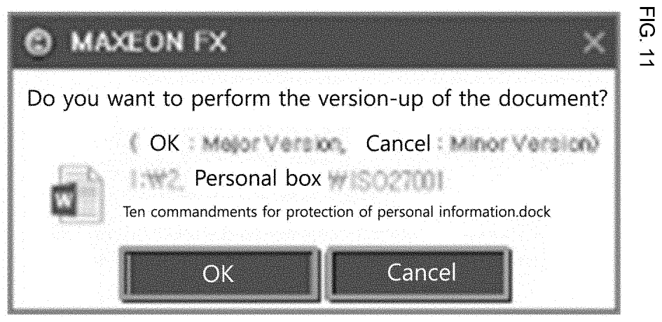

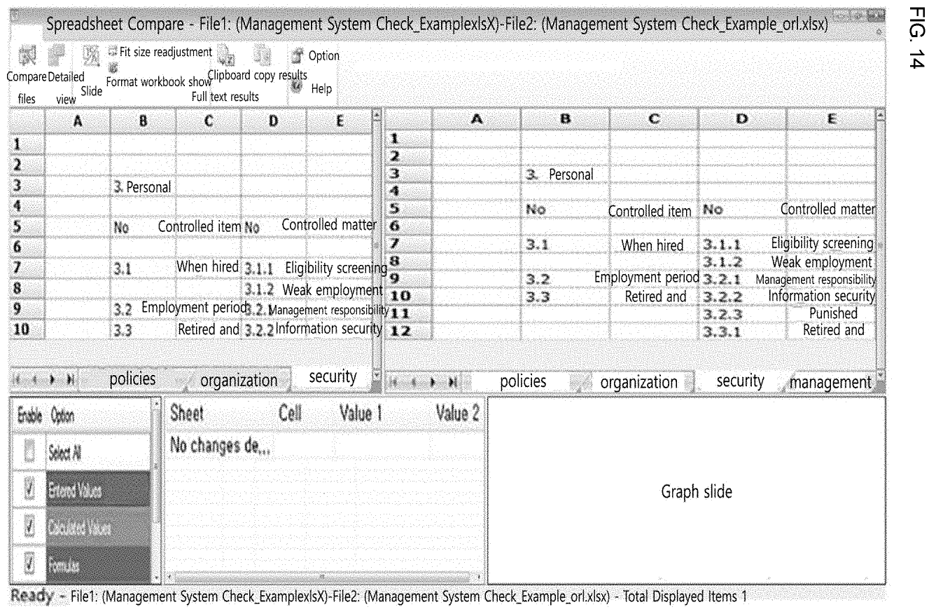

For reference, the content information is information about the content such as text, image or the like, of the shared data, the attribute information is information about the file name, file log and file format of the corresponding shared data, and the version information is information about the per-version content, update history, etc. of the corresponding shared data. The version information includes not only the basic information, such as the file path, file name, creation date, modification date, file size, check-out state, etc., of the corresponding shared data (a file) (see FIGS. 10, 11, and 12), but also comments on the shared data history, which have been made by the user (see FIG. 13), comment information such as replies of other users, etc., and information about the user who has created the shared data. The attribute information generated as described above is stored in the storage server 300 different from the storage servers 300 in which the content information and the version information have been stored.

The search server 200 searches the content information, attribute information and version information related to the shared data in the respective corresponding storage servers 300. In the present embodiment, elastic search technology may be applied to the search server 200. For reference, the elastic search technology is a distributed search engine made based on ‘Apache Lucene,’ and is famous for its easy installation and server expansion.

The privilege management server 400 controls an approval procedure between a user and an administrator for the upload and download processing of the shared data, an approval procedure between the user and the administrator for the execution of an application installed on the user terminal 400, and an approval procedure between the user and the administrator for the connection of a communication application server, such as an e-mail server, groupware, or the like, connected to the user terminal 400 over a communication network and the editing and storage of the shared data. For this purpose, the privilege management server 400 includes: a user checking module 410 which checks approver information obtained by converting the connection relationship between the user having logged in and the administrator having an approval privilege; and an approval processing module 420 which processes whether to execute the shared data or not by executing the approval procedures for the upload and download of the shared data and the execution of the application according to the approver information. In this case, the approver information may be administrator information having an approval privilege for the user and administrator information having an approval privilege for the shared data. The approver information may be included in the attribute information of arbitrary shared data, or may be stored and managed in a separately constructed storage server. Alternatively, the approver information may be stored and managed in the usage privilege management module 140 or user checking module 410.

Meanwhile, an approval terminal 20 is a terminal used by the administrator. An approval module 21 which performs the approval procedure while communicating with the approval processing module 420 which operates in response to an approval request from the user. As a result, the administrator performs the approval procedure according to a procedure presented by the approval module 21, and then approves the execution of the shared data requested by the user.

The gateway server 500 relays communication between the communication network on which the integrated management system is constructed and another communication network. The integrated management system of the present embodiment communicates over a first communication network which is a closed communication network, such as an Ethernet or the like, and an external terminal 30 connected from the outside over a second communication network which is a public communication network, such as the Internet or the like, communicates with the corresponding servers 100, 200, 300, and 400 via the gateway server 500. For reference, the external terminal 30 of the present embodiment is a mobile such as a smartphone or the like, and the gateway server 500 checks a connection through a mobile-dedicated app and allows operation in conjunction with the integrated management system. For reference, when the external terminal 30′ performs communication by a typical terminal such as a laptop or the like rather than communication by a mobile or the like, the external terminal 30′ may connect with the integrated management system via the user terminal 10 the program of which is installed on the external terminal 30′. In other words, the user terminal 10 becomes a gateway. Furthermore, the external terminal 30′ may connect with the user terminal 10 via e-mail, groupware or the like, and may receive corresponding shared data sent by the user terminal 10 within an allowable range. Through this, the external terminal 30′ may access the integrated management system and execute the shared data without the installation of a separate dedicated application.

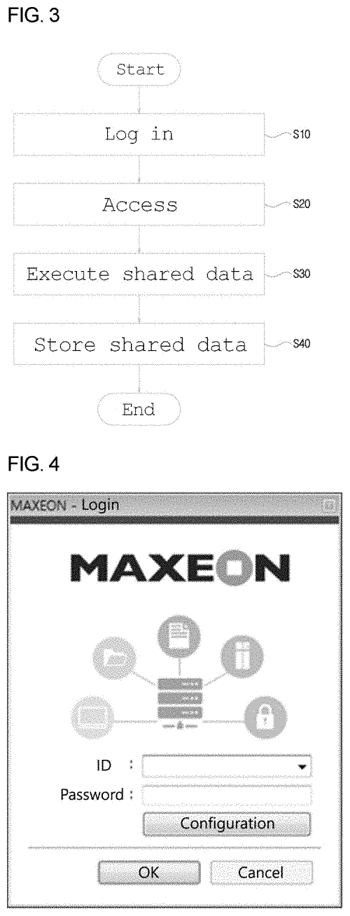

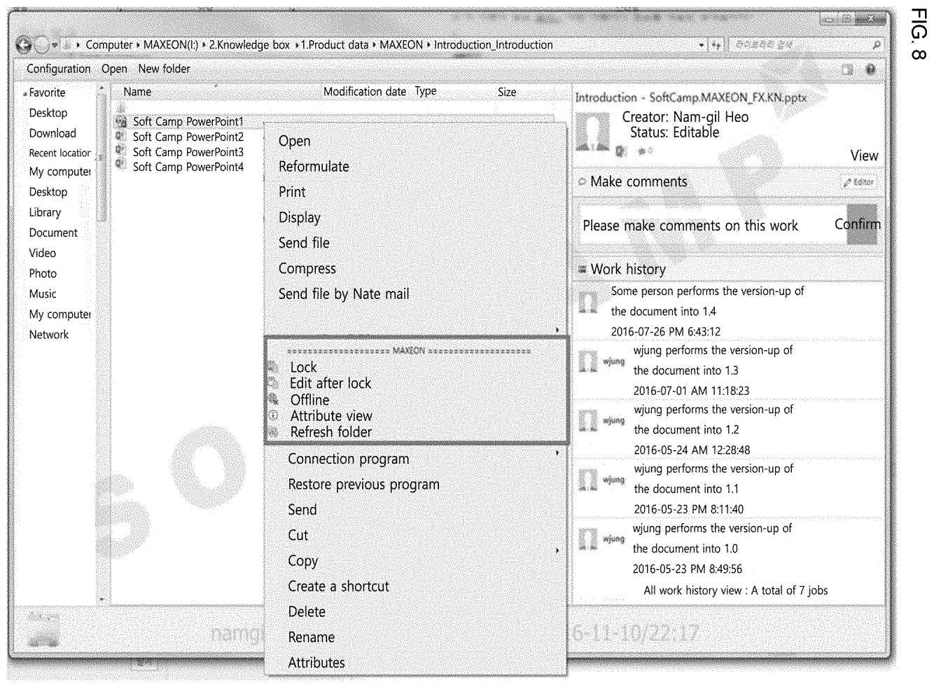

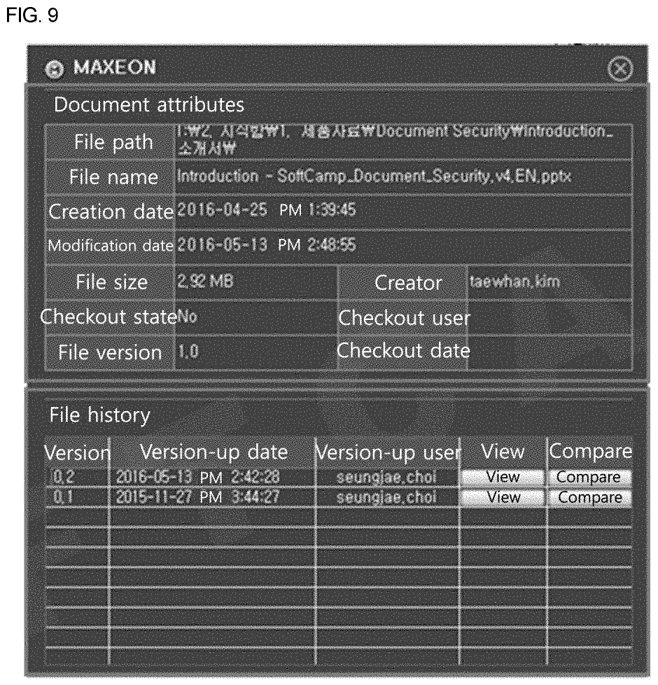

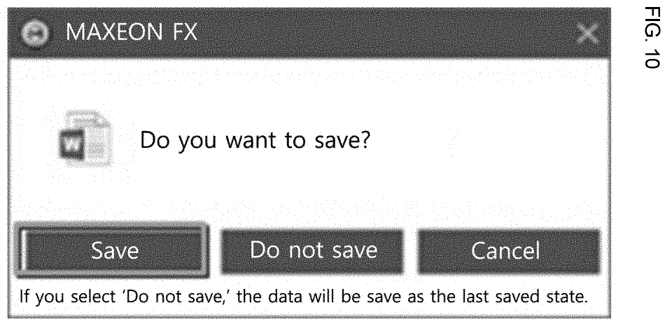

FIG. 3 is a flowchart sequentially showing the operation of the integrated management system according to the present invention, FIGS. 4, 5, and 6 are images showing one embodiment of the login of the integrated management system according to the present invention, FIG. 7 is an image showing one embodiment of the main window of the integrated management system according to the present invention, FIG. 8 is an image showing an embodiment in which shared data is set to checkout in the integrated management system according to the present invention, FIG. 9 is an image showing a popup window which displays the attribute information of shared data in the integrated management system according to the present invention, and FIGS. 10, 11, and 12 are UI images for the execution of the version-up of the integrated management system according to the present invention.

The integrated management system of the present embodiment is sequentially operated as follows:

S10: Login Step

The dedicated application of the present embodiment is installed on the user terminal 10. When the user terminal 10 is booted, the execution module 13 formed in the user terminal 10 outputs an integrated management system access login window, as shown in FIG. 4.

When a user enters his or her ID and password (hereinafter referred to as ‘login information’) into an ID entry field and a password entry field appearing in the login window and clicks an ‘OK’ button, the execution module 13 transfers the corresponding login information of the login module 110 of the execution management server 100. Furthermore, in order to enhance security, the execution module 13 also transfers authentication information, such as an IP address, a unique code, or the like, set in the corresponding user terminal 10, to the login module 110.

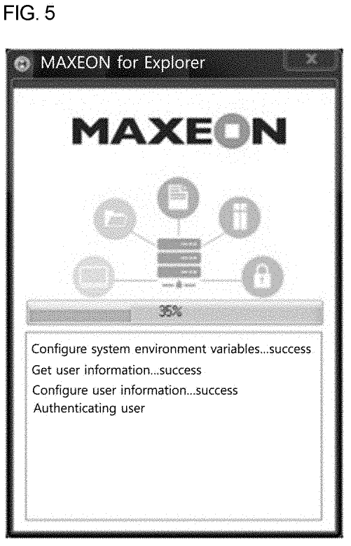

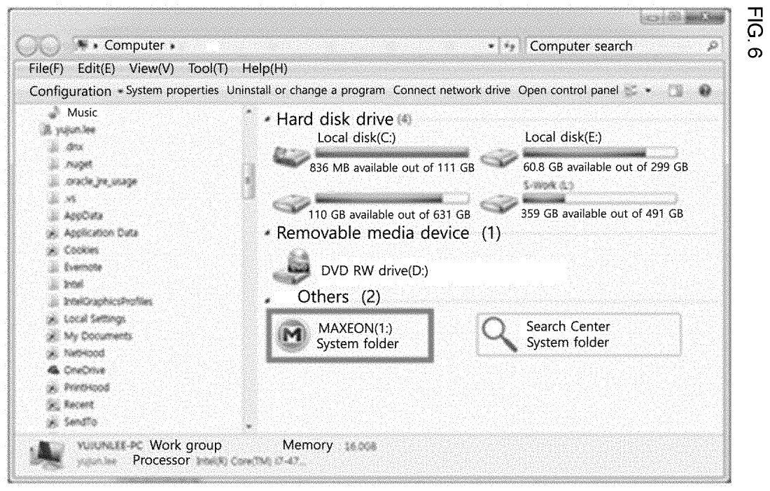

The login module 110 validates the corresponding user by checking the login information, and the authentication module 120 also validates the user terminal 10 by checking the authentication information, as shown in FIG. 5. In this process, the login module 110 or authentication module 120 determines whether to allow access by comparing the login information and the authentication information with each other. When the access is allowed, the upgrade management module 130 determines whether to perform upgrade and performs upgrade by comparing the version of the dedicated application of the user terminal 10 and a current version with each other.

Meanwhile, the usage privilege management module 140 determines a usage privilege for the shared data of a user who is allowed to access the integrated management system, classifies shared data to be disclosed to the user terminal 10 according to corresponding usage privilege information, and controls whether to execute shared data by determining whether a corresponding user has a usage privilege for shared data the execution of which is requested by the execution module 13.

As a result, the execution module 13 outputs shared data only within the range controlled by the permission management module 140, and a user can view and edit corresponding shared data only within the range of the usage privilege information.

S20: Access Step

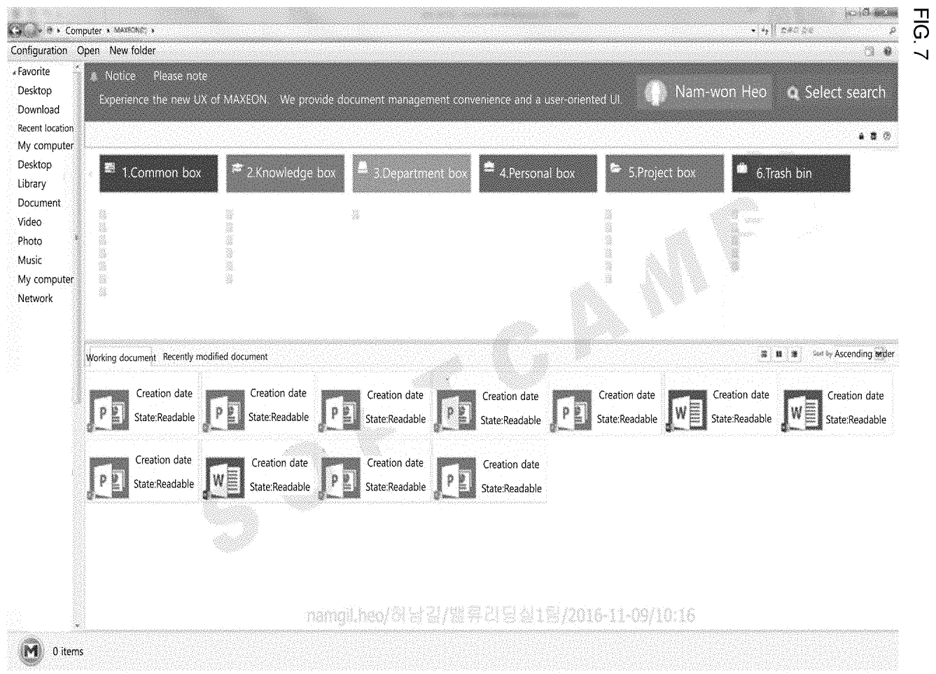

When the user has been validated, the execution module 13 connects with the storage servers 300, and outputs the dedicated drive of the integrated management system into an Explorer, as shown in FIG. 6. Furthermore, when the user clicks the dedicated drive, the execution module 13 outputs a main window in a dashboard form, as shown in FIG. 7.

For reference, the user may access a drive disposed in the user terminal 10 by clicking the local drive of the user terminal 10, and may access a drive disposed in a separate storage server 300 by clicking the dedicated drive in the same manner. The security module 12 of the user terminal 10 prevents shared data stored in the storage server 300 from leaking by limiting the movement of data between the local drive and the dedicated drive.

Meanwhile, as shown in FIG. 7, the execution module 13 of the present embodiment outputs shared data to the dashboard-type main window in a tree structure within the range allowed for the corresponding user. For reference, the main window of the present embodiment outputs folders classified according to the field and purpose of use. R/W privileges for each of document boxes and subfolders are controlled by an administrator. When a user clicks a document box or subfolder, he or she may directly make access. When a user clicks a document box folder or document box subfolder, he or she may directly access a folder for which he or she has a privilege.

For reference, the folder box of the present embodiment includes a common box, a knowledge box, a personal box, a department box, a project box, and a trash bin. The folder box will be described more specifically. The common box stores shared data for common enterprise document forms, and the corresponding shared data can be read only. Instead, the corresponding shared data may be stored in the personal box or department box through a Save As feature. Furthermore, the knowledge box organizes shared data for the technology, marketing materials, etc. of a corporation. Furthermore, the personal box is used as the personal storage of a user, and is limited such that only the corresponding user can access it. Furthermore, the department box is a collaboration space of a department (a part/a team/a business unit) to which the user belongs, and organizes shared data on which collaborative work is performed in the corresponding department. In the present embodiment, the personnel information of the corporation is incorporated into the department box, and a per-department or team folder may be automatically created. Furthermore, the project box organizes shared data, such as proposals or projects, for collaboration among departments. In the present embodiment, a folder named “** Document Centralization Proposal” or the like may be created under the project box, and may be limited such that only a user participating in corresponding work can access the folder. Furthermore, the trash bin can organize shared data deleted in each folder so that it can be restored.

In addition, shared data on which a user is working may be output to the main window. The main window of the present embodiment may list and output the corresponding shared data in an icon image or text form. In this case, an icon image is posted differently according to the state of the same shared data. In the present embodiment, an icon image of shared data which can be viewed and edited, an icon image of shared data which can be edited by a user himself or herself, an icon image of shared data which cannot be edited by a user himself or herself, and an icon image of shared data which is not synchronized with the integrated management system and is stored in the local cache area of the user terminal 10 are displayed visually distinctively.

As described above, when the user accesses the integrated management system through legitimate login, the execution module 13 posts a list of shared data within the privilege range of the user on the main window while operating in conjunction with the execution management server 100.

S30: Shared Data Execution Step

When the user selects shared data for which he or she has a viewing privilege from the shared data posted on the main window, the search server 200 searches the storage servers 300 for the shared data and transmits the shared data to the corresponding user terminal 10, thereby allowing the shared data to be executed on the user terminal 10. The shared data of the present embodiment includes content information, attribute information, and version information. These pieces of information are distributed and stored into the plurality of storage servers 300. Accordingly, when the user attempts to execute specific shared data, the search server 200 searches the plurality of storage servers 300 and collects the corresponding information, and the information collected as described above is executed on the user terminal 10. In this case, an application, such as Excel or the like, may request additional shared data related to the execution of shared data during operation. Accordingly, the storage servers 300 link and store pieces of associated shared data. When the user attempts to search for first shared data, the search server 200 searches for not only the first shared data but also one or more pieces of second shared data linked to the first shared data. Through this, the execution module 13 may immediately execute the required second shared data without requiring an additional search in the storage servers 300 while executing the first shared data, thereby enabling the user to process the shared data at a high speed.

As a result, since the information of a single piece of shared data is distributed, stored and managed separately, the overall shared data can be prevented from being illegitimately leaked by various malicious codes, and stable data execution can be performed in the common storage servers 300 other than a DBMS.

For reference, although the search server 200 is operated to search for shared data for which the user has a viewing privilege, as described above, the search server 200 may be operated to search for specific shared data based on the name of the specific shared data input by the user after directly selecting a “Search center” drive, as shown in FIG. 6.

Thereafter, the security module 12 of the user terminal 10 executes a designated application for the execution of the corresponding shared data, and blocks storage into a local area or the execution of the shared data in another unauthorized application during a execution process.

As described above, shared data is shared and used by a plurality of users. Other users may view and edit the shared data except for data which is posted only for a corresponding user. Accordingly, a user needs to restrain other users from viewing or editing the shared data while working on the same shared data.

For this purpose, the execution module 13 of the present embodiment further includes a check-in/out function for the shared data, and the usage privilege management module 140 adjusts a usage privilege for the corresponding shared data according to the check-in/out settings of the execution module 13. More specifically, when the execution module 13 opens an editing privilege for the shared data via a corresponding application, the usage privilege management module 140 automatically switches the state of the corresponding shared data to check-out, which is a ‘locked’ state, thereby notifying out users that the user is working on the shared data. Thereafter, when another user attempts to execute the shared data, the usage privilege management module 140 performs control such that the shared data is executed only for reading.

For reference, in the integrated management system of the present embodiment, switching to a check-out state may be set through [Lock] or [Edit after Lock] in a right-click menu for the corresponding shared data, as shown in FIG. 8.

Meanwhile, in the integrated management system of the present embodiment, the user may request an approval from the administrator in order to view or edit the shared data for which he or she has no viewing or editing privilege. For this purpose, when the user clicks shared data as desired, the usage privilege management module 140 determines a user privilege for the shared data, and disapproves the execution of the shared data when there is no such a privilege. The execution module 13 receives an execution disapproval signal, transfers a disapproval message to the user, and also outputs an approval request button to the administrator. In this case, when the user clicks the approval request button, the execution module 13 requests the execution of the shared data from the privilege management server 400, the user checking module 410 searches for the approver information of the corresponding user, and the approval processing module 420 inquires of the administrator about whether to approve by controlling the approval module 21 of the administrator terminal 20 determined from the approval approver information. Thereafter, when the administrator approves the execution of the shared data, the approval processing module 420 transfers approval information to the usage privilege management module 140, and the usage privilege management module 140 performs control such that the execution module 13 can execute the shared data.

S40: Shared Data Storage Step

Thereafter, when the user completes the work related to the shared data and terminates only the application or corresponding shared data, the usage privilege management module 140 recognizes check-in for the shared data through the execution module 13, and releases the locked state of the shared data. Furthermore, the execution module 13 stores and updates the shared data in the corresponding storage server 300. For reference, new-version shared data generated by the updating are stored along with the old-version shared data with version information separated, and thus the user can compare the shared data before the update and shared data after the update with each other when required.

Meanwhile, even when the user does not select and execute a check-in menu option after the modification of the shared data, the execution module 13 may automatically perform a version-up procedure. Referring to the present embodiment, when the user completes the creation of shared data and terminates a corresponding application, the execution module 13 outputs a popup window inquiring whether to store the shared data, as shown in FIG. 10. The user may generally determine whether to store the shared data by selecting a selection key such as ‘Save’ or ‘Do not save.’

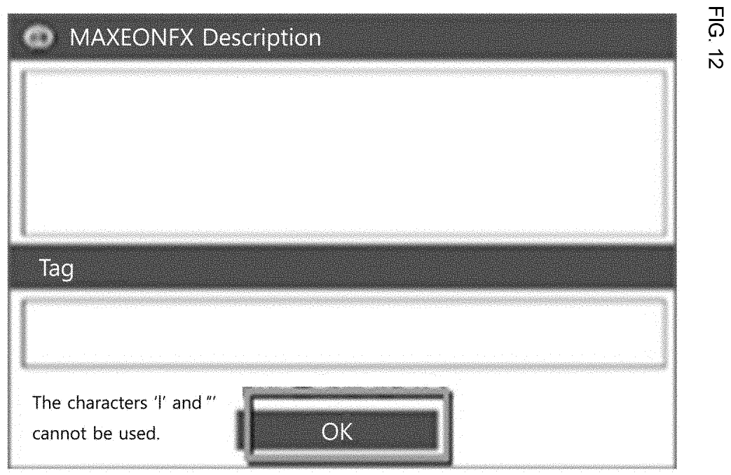

After the shared data has been stored, the execution module 13 outputs a popup window inquiring whether to perform version-up, as shown in FIG. 11. The user selects a selection key such as ‘OK’ or ‘Cancel.’ When the ‘OK’ selection key is selected, the shared data is checked in as a major version, which is one of the version-up formats in the present embodiment. In contrast, when the ‘Cancel’ selection key is selected, the shared data is checked in as a miner version. For reference, the check-in into the major version is performed when there is an overall change in the shared dat. As an example, the indication may be changed from V1.0 to V2.0. Furthermore, the check-in into the miner version is performed when there is an erroneous description in the shared data or a simple change in expression. As an example, the indication is changed from V1.0 to V1.1. In addition, the version-up formats may include two or more various formats. This classification allows the user to check the modifications of the up-version corresponding shared data.

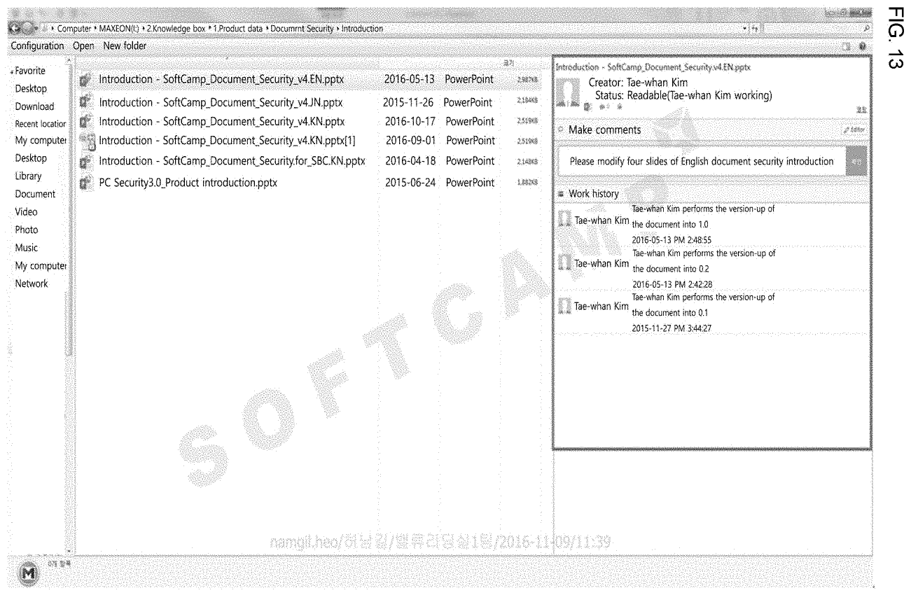

For reference, when the shared data is checked in as a major version, the execution module 13 outputs a popup window through which a tag or an annotation can be input, and the user stores updated shared data by briefly inputting the updated shared data to the popup window, as shown in FIG. 12.

Meanwhile, when the execution module 13 stores storage target shared data under another name in place of the same name, the version-up of the shared data is terminated without being performed, and the shared data which is stored under another name is newly created and stored in a corresponding one of the storage servers 300.

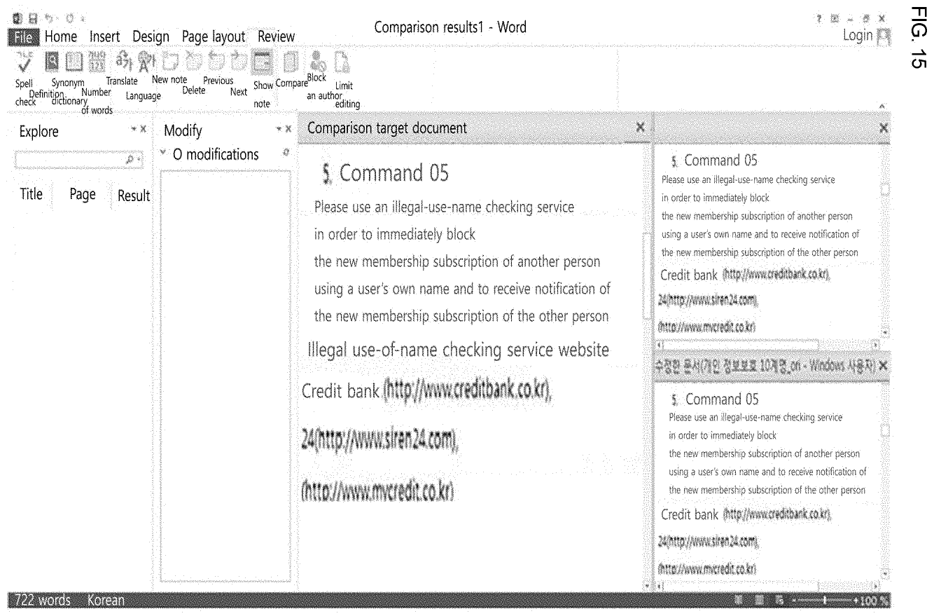

FIGS. 14, 15 and 16 are images showing one embodiment comparing pieces of shared data before and after version-up in the integrated management system according to the present invention.

When the execution module 13 of the present embodiment searches the corresponding storage server 300 for the attribute information of shared data, the popup window shown in FIG. 9 is output, as described above. In the popup window output as described above, comparison buttons are output to a file history sheet so that a user can select and click them. In the present embodiment, the comparison buttons are distinctively output for respective events in which the execution module 13 performs the version-up of corresponding shared data, and the user may select a comparison button for each event.

When the user clicks a desired comparison button in an attribute information-related popup window, the execution module 13 searches a corresponding one of the storage servers 300 for version information via the search server 200, and outputs a shared data document before corresponding version-up and a shared data document after the version-up, as shown in FIGS. 14, 15 and 16.

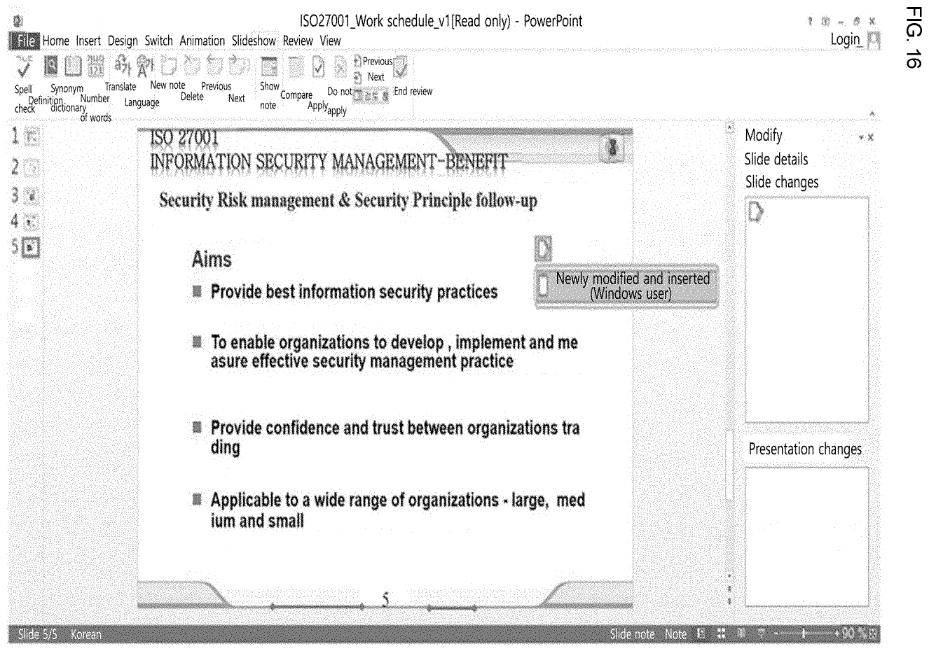

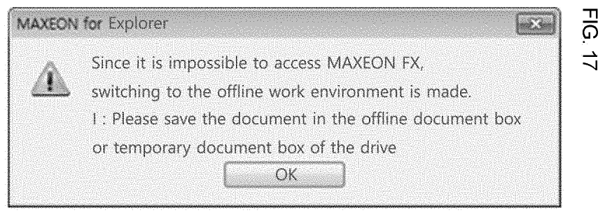

In this case, FIG. 14 shows a case where shared data corresponds to a document generated through an Excel program of Microsoft Corporation, FIG. 15 shows a case where shared data corresponds to a document generated through a Word program of Microsoft Corporation, and FIG. 16 shows a case where shared data corresponds to a document generated through an PowerPoint program of Microsoft Corporation.

As can be seen from the examples of FIGS. 14, 15 and 16, shared data before version-up and shared data after version-up are output together, and thus a user may visually easily compare and determine the updates of the shared data.

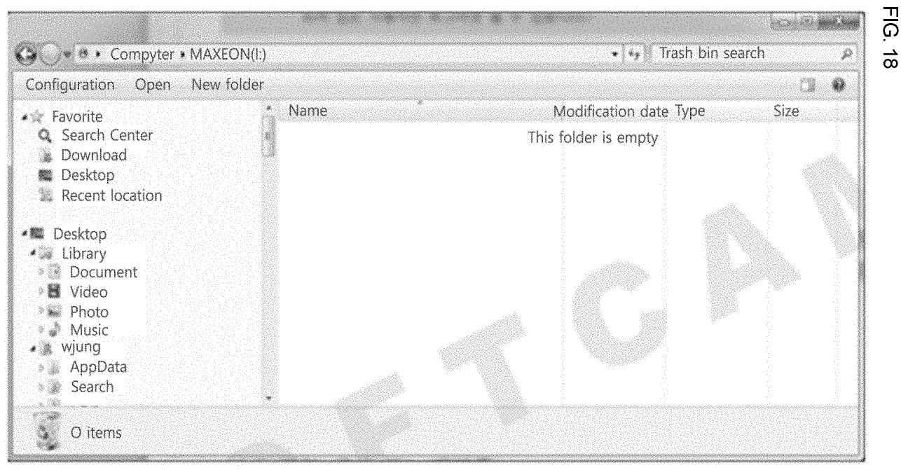

FIGS. 17, 18, 19, and 20 are images showing one embodiment of the offline or emergency mode of the integrated management system according to the present invention.

Meanwhile, there may be a case where a user intentionally switches the user terminal 10 to an offline state (an offline mode) due to one of various reasons while working on shared data, or a case where the user terminal 10 is compulsorily switched to an offline state due to an abnormality of a network (an emergency mode) or the like. In this case, the execution module 13 outputs a warning window shown in FIG. 17, and deforms or discolors a dedicated application icon on a desktop when required.

In addition, after the output of the warning window, the security module 12 blocks the local storage of the shared data, and limits the storage of the shared data only to an offline document box or temporary document box (hereinafter a ‘temporary document box’) which is operated by the dedicated application for its own purpose. The temporary document box is a section encrypted and isolated for shared data. Once the shared data has been stored, the security module 12 processes the isolated space by encrypting it.

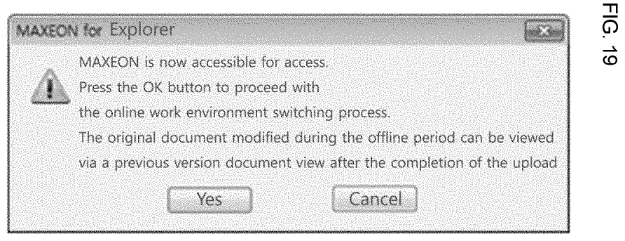

A user outputs a temporary document box shown in FIG. 18 according to the guidance of the warning window, and stores the shared data in the temporary document box.

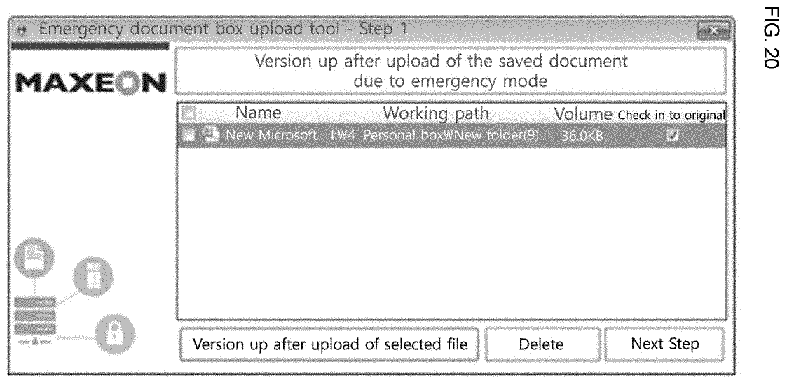

Thereafter, when the execution module 13 becomes aware of online switching through the recovery or restoration of the network, the execution module 13 outputs an online switching guidance window shown in FIG. 19, and outputs an upload window shown in FIG. 20. In this case, the execution module 13 displays the corresponding shared data, stored in the isolated space, on the upload window, and uploads the shared data to the storage servers 300 according to the selection of the user.

Although the foregoing detailed description of the present invention has been given with reference to the preferred embodiments of the present invention, it will be understood by those skilled in the art or those having ordinary knowledge in the art that the present invention may be modified and altered in various manners without departing from the spirit and technical scope of the present invention which are described in the following claims.

1. A data distribution-type integrated management system comprising:
a plurality of storage servers which separates and individually stores two or more types of information selected from among content information, attribute information, and version information which shared data includes;
an execution management server which connects a execution module of a logged-in user terminal to the storage servers; and
a search server which searches the storage servers for the corresponding shared data in response to a request from the user terminal.

2. The data distribution-type integrated management system of claim 1, wherein:
the attribute information includes document content of shared data before version-up and document content of shared data after version-up; and
the execution0020module outputs the attribute information.

3. The data distribution-type integrated management system of claim 2, wherein:
the execution module stores modified shared data, which is a version-up target, in each of a storage server which stores the content information and a storage server which stores the attribute information; and
the execution module divides version-up format into two or more types according to a selection of a user.

4. The data distribution-type integrated management system of claim 1, wherein:
the user terminal configures a security module which blocks illegitimate storage of shared data in a local area; and
the security module forms an encrypted isolated section in the local area and stores shared data being executed in the encrypted isolated section when the execution module becomes aware of switching of the user terminal to an offline state, and the security module uploads the shared data, stored in the isolated section, to the storage servers when the execution module becomes aware of switching of the user terminal to an online state.

5. The data distribution-type integrated management system of claim 1, wherein:
the execution management server includes a usage privilege management module which checks a per-user execution privilege for shared data and controls execution of the corresponding shared data, and the usage privilege management module provides guidance about a locking indication or an unlocking indication to another user depending on whether to execute shared data.

6. The data distribution-type integrated management system of claim 5, wherein:
the usage privilege management module prohibits execution of shared data depending on a user privilege for the shared data, and the execution module transmits an approval request signal in response to a request for approval from the user which corresponds to an execution disapproval signal of the usage privilege management module;
further comprising a privilege management server including: a user checking module configured to check approver information for the user who has transmitted the approval request signal; and an approval processing module transmits approval information, generated by controlling an approval module of a corresponding administrator terminal based on the approver information, to the usage privilege management module so that the usage privilege management module allows the execution module to execute the shared data.

7. The data distribution-type integrated management system of claim 1, wherein:
the storage servers link and store pieces of associated shared data; and
the search server searches for not only first shared data, which is an important search target, but also second shared data linked to the first shared data, and allows the execution module to execute the first and second shared data.
